(19) United States
(12) Patent Application Publication
(10) Pub. No.: US 2017/0114735 A1
(43) Pub. Date: Apr. 27, 2017

(54) INTERNAL COMBUSTION ENGINE WITH ALTERNATING CYLINDER SHUTDOWN

(71) Applicant: Schaeffler Technologies AG & Co. KG, Herzogenaurach (DE)

(72) Inventors: Martin Scheidt, Adelsdorf (DE); Michael Elicker, Adelsdorf (DE); Matthias Lang, Schwaig (DE); Eduard Golovatai-Schmidt, Hemhofen (DE)

(73) Assignee: Schaeffler Technologies AG & Co. KG, Herzogenaurach (DE)

(21) Appl. No.: 15/301,567

(22) PCT Filed: Mar. 5, 2015
(86) PCT No.: PCT/DE2015/200123

§ 371 Date: Oct. 3, 2016

(30) Foreign Application Priority Data
Apr. 2, 2014 (DE) 10 2014 206 305.1

(51) Int. Cl. F02D 41/00; F02D 17/02; F02D 13/06

(52) U.S. Cl. CPC F02D 41/006; F02D 13/06; F02D 17/02; F02D 41/0087; F02D 41/0002; F02D 2041/0012

(57) ABSTRACT

The invention relates to a method for the alternating cylinder shutdown of a three-cylinder or five-cylinder internal combustion engine during partial load operation, in which the opening of the gas exchange valves of the shut-down cylinders is deactivated. The valve deactivation of the shut-down cylinders is intended to begin and end with the deactivation and the subsequent reactivation of the intake valves of said cylinders, in each case at the start of the regular intake cycle of said cylinders.

The invention relates to a method for the alternating cylinder shutdown of a three-cylinder or five-cylinder internal combustion engine in partial load operation in which the gas exchange valves of the shutdown cylinder are deactivated.

### BACKGROUND

Especially in gas engines, the shutdown of individual cylinders is a proven option, in the partial load range, for displacing the operating point of the other cylinders to a higher load point with better efficiency and more favorable fuel consumption accordingly. The improvement of efficiency results significantly from the de-throttling of the load change, so that the consumption potential that can be reduced basically increases with the displacement of the engine. Internal combustion engines with cylinder shutdown are therefore typically large-volume eight-cylinder and twelve-cylinder engines. In the course of ongoing trends of downsizing, however, in the meantime four-cylinder engines are also being equipped with cylinder shutdown on the market—see, for example, MTZ 03/2012 “The 1.4-L TSI Gasoline Engine with Cylinder Shutdown.”

It is also known to equip internal combustion engines with an odd number of cylinders, thus, in practice, three-cylinder and five-cylinder in-line engines, with cylinder shutdown. Differently than for engines with an even number of cylinders, however, in this case the permanent shutdown of one or the same cylinders would lead to a non-uniform ignition spacing with corresponding rough running. As proposed in DE 10 2010 037 362 A1, this disadvantage can be compensated by a so-called alternating (also designated as rolling) shutdown of the cylinders. Here, the uniformity of the ignition spacing remains unchanged in that all of the cylinders of the engine can be shut down and that every second cylinder in the ignition sequence is always shut down for a working cycle. In three-cylinder in-line engines, this results in the engine being operated with the ignition sequence 1-2-3 in the non-shutdown full-engine operation and with the ignition sequence 1-3-2 with 480° crankshaft ignition spacing in the cylinder shutdown operation. For the five-cylinder engine with the ignition sequence 1-2-4-5-3, the shutdown ignition sequence 1-4-3-2-5 with 288° ignition spacing is produced analogously.

The resulting advantages that the valve actuation is deactivated during the shutdown working cycle or cycles of the affected cylinder and consequently the gas exchange valves remain closed are known. Thus, the initially cited DE 10 2010 037 362 A1 proposes operating the shutdown cylinder with closed gas exchange valves and enclosed air, which acts like a low-friction air spring in the additional compression and suction cycle.

In contrast, EP 2 669 495 A1 is more favorable for operating the shutdown cylinder with exhaust gas enclosed therein. Here, the exhaust gas should be limited by a last exhaust valve stroke with reduced opening cross section to a quantity such that, on one hand, auto-ignition/knocking is not generated due to too high a cylinder pressure and, on the other hand, an uncontrolled opening of the gas exchange valves is prevented due to too low a cylinder internal pressure.

The shutdown method known from EP 0 779 427 A2 also compresses enclosed exhaust gas, wherein both during shutdown and also subsequent actuation of the cylinder, first the exhaust and then the intake are always deactivated or reactivated. The hot exhaust gas enclosed in the cylinder should prevent undesired cooling of the cylinder and reactivating the exhaust valve before the intake valve prevents mixing of the exhaust gas remaining in the cylinder with fresh air that would be unfavorable for the subsequent combustion process.

### SUMMARY

The present invention is based on the objective of providing a method for the alternating cylinder shutdown of a three-cylinder or five-cylinder internal combustion engine, by means of which the partial load consumption of the engine can be further reduced.

To achieve this object, the valve deactivation of the shutdown cylinder starts or ends with the deactivation and the subsequent reactivation of the intake valves of this cylinder each at the beginning of its regular suction cycle. Differently than for the known control times for deactivating the gas exchange valves, in which the shutdown cylinder is filled with fresh air or exhaust gas and this filling is first compressed and then expanded, the method according to the invention provides a cylinder shutdown operation in which each shutdown cylinder is operated essentially in an emptied state. In a greatly simplified explanation that neglects the cylinder residual filling caused by the compression volume and the valve closing times, the shutdown cylinder is thus operated with an enclosed vacuum.

Comparative simulations of the application have shown that this method of alternating cylinder shutdown offers the greatest fuel consumption potentials. Significant causes here are the extremely low wall heat and blow-by losses, which are otherwise associated with the compression and expansion of exhaust gas or fresh air and significantly compensate the efficiency advantage achieved with the cylinder shutdown.

In addition, the intake valves of the shutdown cylinder are opened directly before their deactivation with a variable adjustable additional stroke within the crankshaft angle range in which lies the regular push-out cycle of this cylinder. Due to the optional, additional opening of the intake valves in the push-out cycle, internal exhaust gas recirculation (EGR) overlaps the subsequent shutdown of this cylinder, in that a part of the exhaust gas is pushed out into the intake channel and is kept there until the next suction cycle.

The residual gas quantity enclosed in each shutdown cylinder can alternatively also be set by advanced exhaust closing. The control times of the shutdown cylinder are then set so that the exhaust valves close before the charge cycle top dead center (TDC) and before the deactivation of the intake valves of this cylinder.

As another alternative for setting the residual gas quantity enclosed in the shutdown cylinder, there is also the possibility of retarded exhaust closing after the charge cycle TDC, wherein a part of the pushed-out exhaust gas is suctioned in again.

The mechanism required for deactivating and reactivating the gas exchange valves can basically be realized with all known valve drives that permit complete shutdown of the valves. With respect to the comparatively high frequency activation and reactivation, electrohydraulic valve trains are especially suitable, because these have constructions that permit extremely fast and consequently accurate cycle switching and also allow the full-variable setting of the valve stroke of the valve control times by means of shutting down the gas exchange valves. If both the intake-side and also exhaust-side valve train is fully variable, on one hand, the operating-point displacing cylinder shutdown can be combined with a throttle-free load control (as is known, the quantity is regulated mainly by means of the opening cross section of the intake valves and less by means of the throttle valve position) and, on the other hand, the advanced exhaust closing control time can also be set fully variable on the exhaust side. Electrohydraulic valve trains that are suitable for this purpose are known not only from numerous references, but are also on the market from the automobile manufacturer FIAT under the designation “Multiair” or “Twinair.”

As another patent reference, EP 1 321 634 A2 is mentioned, which discloses a five-cylinder in-line engine with electrohydraulic valve control, alternating cylinder shutdown, and internal exhaust gas recirculation. The electrohydraulic valve control actuates the intake valves, while the shutdown of the exhaust valves can be realized with relatively simple on/off cam switches. Other details on the option of EGR mentioned above can be found in EP 2 397 674 A1, which discloses an electrohydraulic valve control with a variable adjustable intake stroke in the push-out cycle for an internal combustion engine with cylinder shutdown.

For the sake of completeness, it is mentioned that any internal combustion engine with n cylinders can be operated with the method according to the invention, if every p-th cycle in the ignition sequence is fired and if n and p are coprime, so that each cylinder is cyclically switched on and off. Here, it is also not absolutely necessary that the cylinders are switched on and off alternately for each working cycle. Thus, for example, the three-cylinder engine could also be operated in the mode 1-(2-3-1)-2-(3-1-2)-3-(1-2-3)-1- . . . and the five-cylinder engine could be operated in the mode 1-(2-4)-5-(3-1)-2-(4-5)-3-(1-2)-4-(5-3)-1- . . . or 1-(2-4-5)-3-(1-2-4)-5-(3-1-2)-4-(5-3-1)-2-(4-5-3)-1- . . . , etc., wherein the cylinders in parentheses are shut down. Obviously, the invention is not restricted to either use in in-line engines or in multi-valve engines.

### BRIEF DESCRIPTION OF THE DRAWINGS

Additional features of the invention are given from the following description and from the drawings in which three embodiments of the method are each shown with reference to the control times of one of the shutdown cylinders. Shown are:

FIG. 1 the known method in which the shutdown cylinders are operated with exhaust gas enclosed therein,

FIG. 2 the known method in which the shutdown cylinders are operated with fresh air enclosed therein,

FIG. 3 the first embodiment of the method according to the invention, in which the shutdown cylinders are operated in a quasi-emptied state,

FIG. 4 in relative comparison, the simulated fuel consumption of a 1-liter three-cylinder engine at the reference point n=2000 rpm, pme=2 bar for different cylinder shutdown methods,

FIG. 5 the second embodiment of the method according to the invention, in which the exhaust valves of the cylinders to be shut down are closed at an advanced time,

FIG. 6 the third embodiment of the method according to the invention in which the cylinders to be shut down are operated with expanded EGR.

### DETAILED DESCRIPTION OF THE PREFERRED EMBODIMENTS

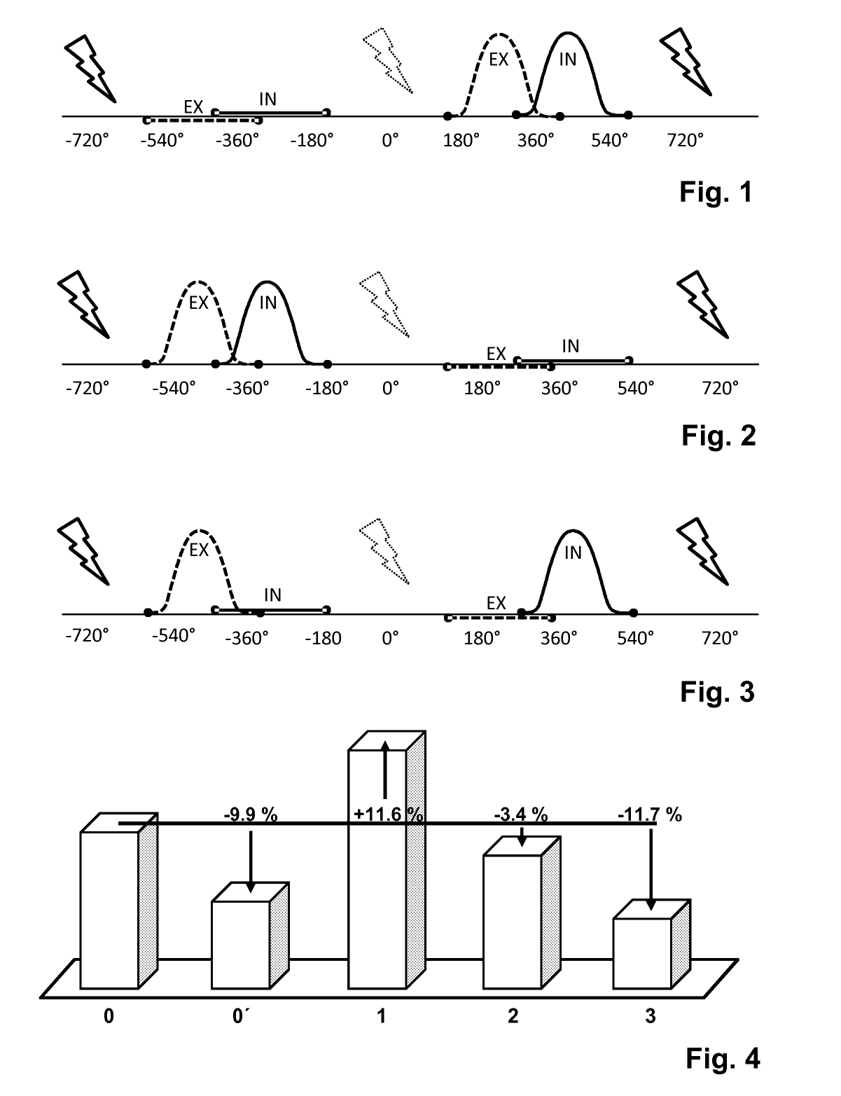

The invention is explained starting from the known method of alternating cylinder shutdown, in which the cylinders are operated in the shutdown state either according to FIG. 1 under the inclusion of exhaust gas or according to FIG. 2 under the inclusion of fresh air. Plotted in each are the valve stroke EX of the exhaust valve (dashed line) and IN of the intake valve (solid line) of one of the cylinders over two working cycles of the internal combustion engine between −720° and +720° crankshaft angle. The horizontal valve stroke lines designate the crankshaft angle within which the gas exchange valves are deactivated and consequently remain closed relative to their regular (activated) valve lifting. The lightning bolts drawn at each ignition TDC indicate whether combustion takes place in the cylinder or not. As symbolized by the lightning bolt drawn with a thin and dashed line, the cylinder is switched off at 0°.

FIG. 1: The valve deactivation of the shut-down cylinder begins with the deactivation of the exhaust valve or valves of this cylinder and ends with the subsequent reactivation of the exhaust valves of this cylinder. In other words, the exhaust valves of the cylinder to be shut down are always first deactivated and then reactivated. The exhaust gas enclosed in the shutdown cylinder is compressed and expanded twice during the shutdown cycle, wherein efficiency-reducing wall heat and blow-by losses are produced.

FIG. 2: In this case, the exhaust valves are also always first deactivated and then reactivated. However, the sequence of this activation with respect to the shutdown ignition TDC for the method according to FIG. 1 is reversed, so that now the shutdown cylinder compresses and expands fresh air twice. This method is also associated with efficiency-reducing wall heat and blow-by losses.

In the cylinder shutdown method according to the invention according to FIG. 3, the control times of the cylinder to be shut down are set so that the valve deactivation begins with the deactivation of the intake valve or valves at the beginning of the regular suction cycle of this cylinder and ends with the reactivation of the intake valves at the beginning of the subsequent regular suction cycle. Differently than in the known method, in this case, the intake valves are always first deactivated and then reactivated, wherein the “charge cycle” preceding the shutdown ignition TDC is performed essentially with the pushing out of exhaust gas but without the suctioning in of fresh air and wherein the charge cycle following the shutdown ignition TDC is performed essentially without the pushing out of exhaust gas but with the suctioning in of fresh air. In-between, the enclosed residual gas quantity is first expanded and then compressed twice each time in succession. The residual gas quantity is the low exhaust gas quantity that the cylinder encloses during the exhaust closing—the closing time is, in this embodiment, after the charge cycle TDC.

The bar chart (FIG. 4) shows simulated fuel consumption values of a 1.0-liter in-line three-cylinder engine at the typical reference point for rotational speed n=2000 rpm and the effective average pressure pme=2 bar. The bar designated with 0 corresponds to the base operation without cylinder shut down for a relative consumption of 100%.

The bar designated with 0′ represents the consumption of the engine when the second cylinder is shut down permanently. The already very favorable reduced consumption at nearly 10% is nevertheless not relevant to practice because the rough running of such a cylinder shutdown is not only greatly unacceptable, but would also likely lead to premature fatigue fracture of the crankshaft.

The bar 1 stands for the known method according to FIG. 1 in which the cylinders alternately shut down with 480° ignition spacing are operated with the inclusion of exhaust gas. The efficiency losses explained above overcompensate the consumption-reducing throttling due to the cylinder shutdown and even cause increased consumption of 11.6%.

The bar 2 reflects the known method according to FIG. 2 in which the cylinders alternately shut down with 480° ignition spacing are operated with the inclusion of fresh air. This arrangement produces a consumption advantage of 3.4% with acceptable engine running.

The bar 3 shows the significant consumption advantage, nearly 12%, with the method according to the invention according to FIG. 3 in which the cylinders alternately shut down with 480° ignition spacing are operated virtually under the inclusion of a vacuum.

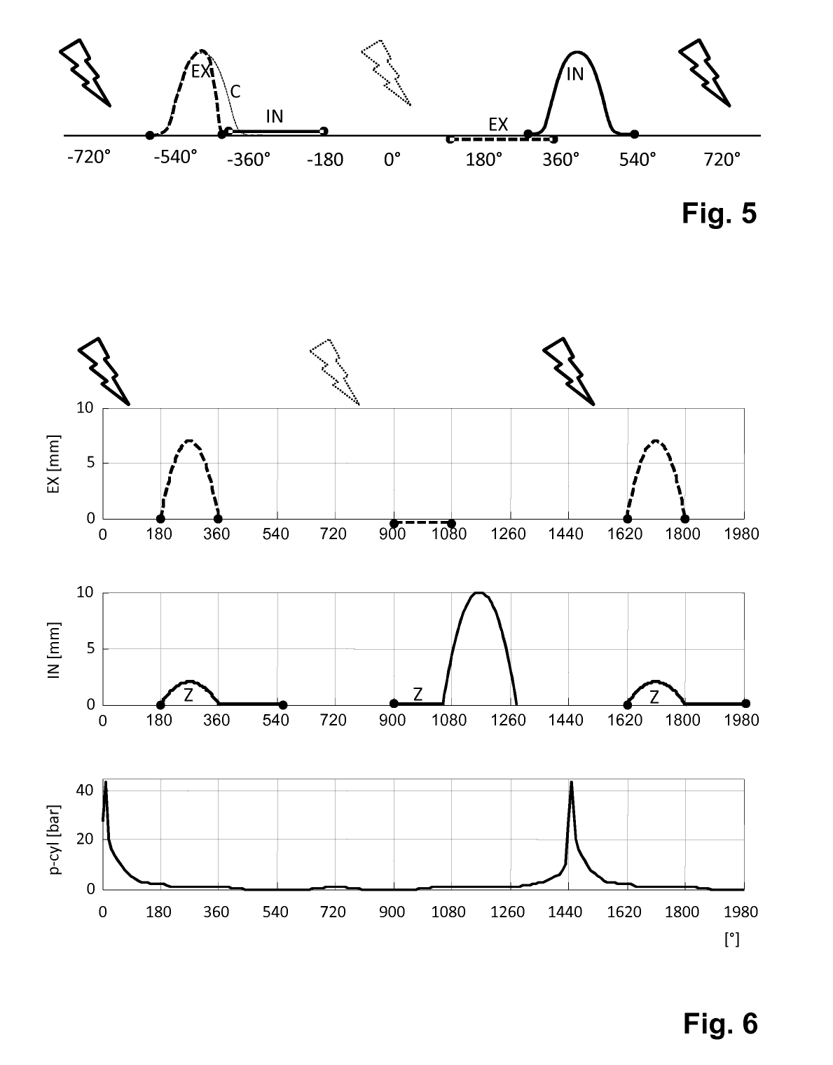

In the second embodiment of the method according to the invention according to FIG. 5, the exhaust valves are fully variably stroke-actuated by an electrohydraulic valve train. Here, the hydraulics mounted between the actuating exhaust cam and the associated exhaust valve are changed such that the exhaust valve closes at an advanced time before the charge cycle TDC and the regular opening time of the then deactivated intake valve. This is shown by the significantly more advanced closing time of the exhaust stroke EX shown with a thick line relative to the envelope curve C of the exhaust cam shown with a thin line as a measure for the maximum possible exhaust stroke. The residual gas quantity set with this advanced exhaust closing control time is then expanded and compressed twice with low losses, as previously explained.

The third embodiment of the method according to the invention shown in FIG. 6 comprises an expanded residual gas control. The exhaust stroke EX and the intake stroke IN are here plotted relative to each other in separate diagrams relative to the crankshaft angle. In this embodiment, the valve deactivation of each shutdown cylinder also begins with the deactivation of the intake stroke IN and ends with its subsequent reactivation, each beginning with the regular suction cycle of this cylinder in which essentially fresh air is suctioned in. The cam lifting actuating each intake valve is provided, however, with an additional stroke Z that opens the intake valve directly before its deactivation within the regular push-out cycle of this cylinder, i.e., at the same time with the open exhaust valve. The additional stroke Z that can also be realized by a fully variable electrohydraulic valve control can be completely deactivated as is the case up to the subsequent reactivation of the intake valve at the beginning of the regular suction cycle.

As already explained above, the additional stroke Z causes expanded internal EGR, wherein a part of the exhaust gas is pushed out into the intake channel that is simultaneously opened with the exhaust channel and remains there in front of the intake valve until a new suction cycle of the same cylinder, in order to then be suctioned in with fresh air.

The pressure curve shown in the lower diagram shows the cylinder internal pressure p-cyl associated with the crankshaft angle as an absolute pressure. This is located during the shutdown working cycle at an extremely low and barely variable level, whereby the efficiency-reducing wall heat and blow-by losses of the known cylinder shutdown method are avoided.

1. A method for alternating cylinder shutdown of a three-cylinder or five-cylinder internal combustion engine in partial load operation, the method comprising deactivating an opening of gas exchange valves of a shutdown cylinder, and subsequently reactivating the opening of the gas exchange valves of the shutdown cylinder, wherein the valve deactivation of the shutdown cylinder at least one of begins or ends with the deactivation and the subsequent reactivation of the intake valves of said cylinder each at a beginning of a regular suction cycle.

2. The method according to claim 1, further comprising opening the intake valves of the shutdown cylinder directly before their deactivation with a variably adjustable additional stroke (Z) within a crankshaft angle range in which lies a regular push-out cycle of said cylinder.

3. The method according to claim 1, further comprising closing exhaust valves of the shutdown cylinder to close said cylinder before deactivating the intake valves.
